(19) United States
(12) Patent Application Publication
(10) Pub. No.: US 2018/0286078 A1
(43) Pub. Date: Oct. 4, 2018

(54) VEHICLE-MOUNTED CAMERA CALIBRATION SYSTEM

(71) Applicant: Panasonic Intellectual Property Management Co., Ltd., Osaka (JP)

(72) Inventors: DAISUKE KIMOTO, Osaka (JP); RYUICHI MATO, Kanagawa (JP)

(21) Appl. No.: 15/997,806

(22) Filed: Jun. 5, 2018

Related U.S. Application Data
(63) Continuation of application No. PCT/JP2017/002092, filed on Jan. 23, 2017.

(30) Foreign Application Priority Data
Feb. 3, 2016 (JP) 2016-019072

(51) Int. Cl. G06T 7/80; G06T 7/246; B60R 11/04

(52) U.S. Cl. CPC G06T 7/80; G06T 2207/30252; B60R 11/04; G06T 7/246

(57) ABSTRACT

A vehicle-mounted camera calibration system is provided. This system automatically calibrates camera images during the transfer of vehicles on an assembly line of the vehicles without stopping the vehicles on the assembly line. This system includes a camera mounted to each one of the vehicles for sequentially shooting an image of a road surface, a memory for chronologically storing the images shot with the camera, a featuring-point extractor for extracting a featuring point from each of the shot images stored in the memory, a tracking-point extractor for extracting a tracking point that represents a position to which the featuring point has been transferred after a lapse of a given time, and a camera-calibration parameter calculator for calculating a calibration parameter to be used for calibrating images shot by the camera, from the featuring point and the tracking point.

### CROSS-REFERENCE TO RELATED APPLICATIONS

This application is a continuation of the PCT International Application No. PCT/JP2017/002092 filed on Jan. 23, 2017, which claims the benefit of foreign priority of Japanese patent application No. 2016-019072 filed on Feb. 3, 2016, the contents all of which are incorporated herein by reference.

### BACKGROUND

### 1. Technical Field

The present disclosure relates to a vehicle-mounted camera calibration system that uses an image shot with a camera for calibrating an image to be displayed on a vehicle-mounted monitor. Hereinafter, the image to be displayed on a vehicle-mounted monitor is referred as a camera image.

### 2. Description of the Related Art

Conventionally, an image, shot with a vehicle-mounted camera, behind the vehicle is displayed on a vehicle-mounted monitor for a driver to recognize a blind spot, viz. a situation right behind the vehicle. This kind of displaying the image improves visibility by a driver when the driver reverses the car.

In order to display the image shot with the vehicle-mounted camera on the vehicle-mounted monitor, it is necessary to calibrate a mounting status of the camera to the vehicle. To calibrate the mounting status, a calibrating target is placed behind the vehicle, then a worker adjusts the mounting status of the camera to the vehicle so that the image of the calibrating target can be properly displayed on the monitor while monitoring the image of the calibrating target.

The image shot with the vehicle-mounted camera undergoes a given computation process based on the image of the calibrating target, thereby calibrating properly an image displayed on the vehicle-mounted monitor.

There is another technology to display an image. According to the technology, scenes around the vehicle are shot with a plurality of vehicle-mounted cameras, and the images shot with these cameras are converted into bird's-eye view images looked down from right above the vehicle. At the same time, a mapping is done with adjustments of positions among the images, whereby a single synthetic image in which the viewpoint is converted is obtainable. In such a case, an accurate alignment between two adjacent images is needed, so that a highly accurate calibration is required.

However, to carry out such a conventional calibration method, it is necessary to place the calibrating target and the vehicle so as to satisfy a strict relative positional relation between them. To achieve the placement, the calibrating target should be placed accurately with respect to the vehicle after the vehicle is placed, or the vehicle should be placed accurately with respect to the calibrating target after the calibrating target is placed.

Therefore, an assembly line of vehicles is modified with a cost so that an accuracy of alignment between the vehicle and the calibrating target can be improved. On top of that, the vehicle shipped out from the production site is sometimes re-calibrated at a maintenance section of a sales-maintenance company (e.g. for repairs or retrofitting a vehicle-mounted camera to the vehicle). In such a case, the calibrating target should be accurately placed each time, which further requires time and labor.

In such a situation, a new calibrating method is desired such that the new method needs less accuracy in relative placements of the vehicle and the calibrating target. Actually some techniques for achieving the new method have been proposed.

For instance, Unexamined Japanese Patent Publication No. 2012-015576 (hereinafter referred as PTL 1) discloses a method in which a lattice of white lines is used as the calibrating target, and characteristics regardless of a standstill state of the vehicle such as a linearity, parallelism, orthogonal degree, and intervals of the lattice are used for calibrating an inner parameter, distortion parameter, and outer parameter of cameras.

Unexamined Japanese Patent Publication No. 2009-118414 (hereinafter referred as PTL 2) discloses a method, in which the calibrating target and a target for assessing a calibration accuracy are unified together, is used for calibration.

### SUMMARY

The present disclosure addresses the problems discussed above, and aims to provide a vehicle-mounted camera calibration system that can calibrate the images shot with the vehicle-mounted camera without stopping vehicles on the assembly line.

The vehicle-mounted camera calibration system of the present disclosure includes a camera, a memory, a featuring-point extractor, a tracking-point extractor, and a camera-calibration parameter calculator. The camera is mounted to a vehicle, shoots images of a road surface sequentially. The memory chronologically stores the images shot with the camera. The featuring-point extractor extracts a featuring point from each of the shot images stored in the memory. The tracking-point extractor extracts a tracking point representing a position to which the featuring point has moved after a lapse of a given time. The camera-calibration parameter calculator calculates a calibration parameter from the featuring point and the tracking point. The calibration parameter is to be used for calibrating images shot by the camera.

According to the present disclosure, it is possible to calibrate the camera images automatically during a transfer of the vehicle on the assembly line without stopping each of vehicles on an assembly line of the vehicles. In other words, the images to be displayed on the vehicle-mounted display can be calibrated with no need to position each of the vehicles.

### BRIEF DESCRIPTION OF DRAWINGS

FIG. 1 is a block diagram showing a functional structure of a camera calibrating device in accordance with a first embodiment of the present disclosure.

FIG. 2 shows imaginal coordinates of featuring points of the Nth image stored in a memory.

FIG. 3 shows imaginal coordinates of tracking points of the (N+1)th image stored in the memory.

FIG. 4 is a flowchart of calculating a calibration parameter.

FIG. 5 is a flowchart of converting the imaginal coordinate of each of the featuring point and the tracking point stored in the memory into a world coordinate.

FIG. 6A illustrates coordinate axes and rotations about the respective coordinate axes of a world coordinate.

FIG. 6B illustrates the coordinate axes and the rotations about the respective coordinate axes of the world coordinate.

FIG. 7 illustrates a process of converting the imaginal coordinates of the featuring point and the tracking point into the world coordinates.

FIG. 8 illustrates a process of calculating a difference in transfer distances of a mobile body.

FIG. 9 is a block diagram showing a functional structure of a camera calibrating device in accordance with a second embodiment of the present disclosure.

FIG. 10 is a flowchart illustrating a process of calculating a transfer distance of the mobile body, to be performed in a mobile-body transfer-distance calculator.

FIG. 11 illustrates a process of calculating a transfer distance in a real world based on relative translation matrix T and relative rotation matrix R of the camera between before and after the transfer.

### DETAILED DESCRIPTION OF PREFERRED EMBODIMENTS

Prior to description of the exemplary embodiments of the present disclosure, the problem in the related art is described briefly. In PTL 1 and 2, each of the vehicles is required to be standstill within a calibrating target, so that a worker in the assembly line of vehicles should stop each vehicle within the calibrating target. This job incurs time and labor (i.e. cost).

### First Exemplary Embodiment

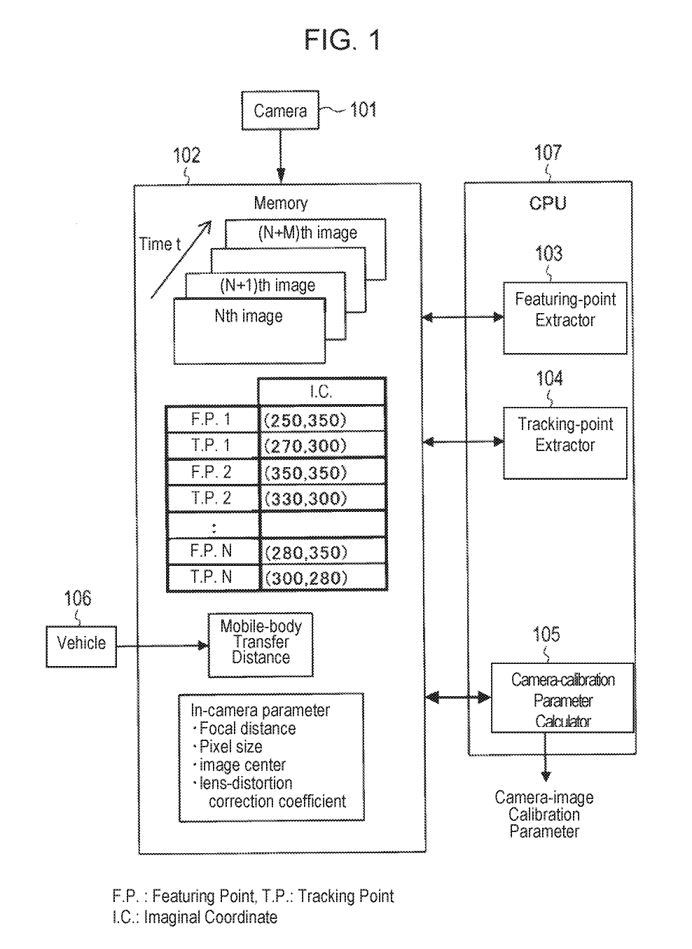

Exemplary embodiments of the present disclosure will be detailed hereinafter with reference to the accompanying drawings. FIG. 1 is a block diagram showing the functional structure of the camera calibrating device in accordance with a first exemplary embodiment of the present disclosure. The structure and the operation of the camera calibrating device in accordance with the first exemplary embodiment are demonstrated hereinafter.

The camera calibrating device in accordance with the present exemplary embodiment is mounted to a mobile body such as a vehicle. This device is expected to calibrate images shot with camera 101, and includes memory 102, featuring-point extractor 103, tracking-point extractor 104, and camera-calibration parameter calculator 105. FIG. 1 also shows vehicle 106.

When CPU (central processing unit) 107 of the camera calibrating device executes a program stored in a ROM (read only memory, not shown), thereby featuring-point extractor 103, tracking-point extractor 104, and camera-calibration parameter calculator 105 are implemented. Instead of using the CPU and ROM, dedicated circuits formed of hardware can be used for implementing each of those sections.

Camera 101 is mounted to the vehicle, and shoots images of a road surface during the transfer of the vehicle. The images are then stored sequentially in memory 102.

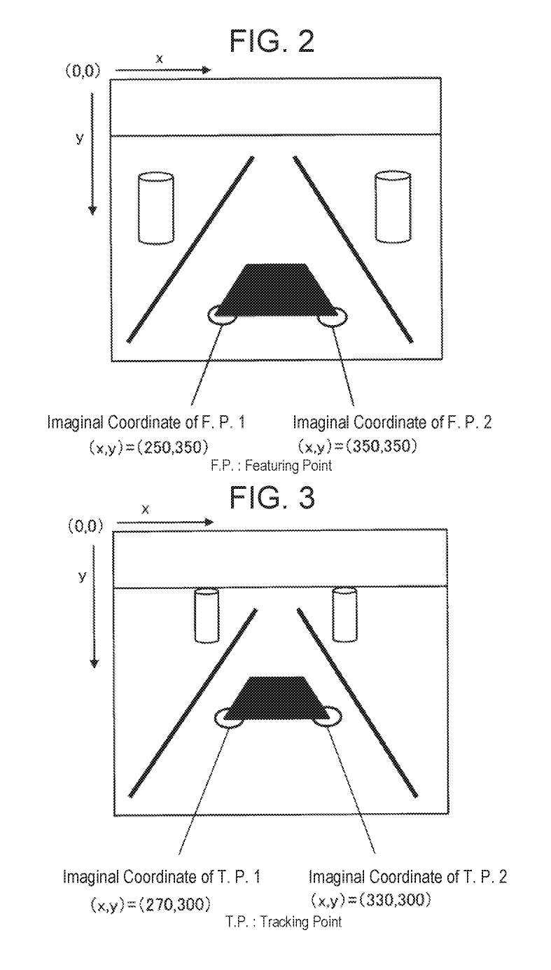

Featuring-point extractor 103 extracts featuring points from the Nth image stored in memory 102 as shown in FIG. 2, and stores the imaginal coordinates of those featuring points. The imaginal coordinate refers to a two-dimensional coordinate system of which origin is located at upper left of an image stored in the memory. The featuring-point refers to a point included in a given area of which brightness has a characteristic amount of information. For instance, a Harris Corner Point is searched as an example of the featuring point.

Tracking-point extractor 104 extracts points from the (N+1)th image stored in memory 102 as shown in FIG. 3. This points have the same features as the respective featuring points. Tracking-point extractor 104 stores the imaginal coordinates of the tracking points in memory 102. The extraction of the tracking points adopts a processing method such as Kanade-Lucas-Thmasi (KLT) method.

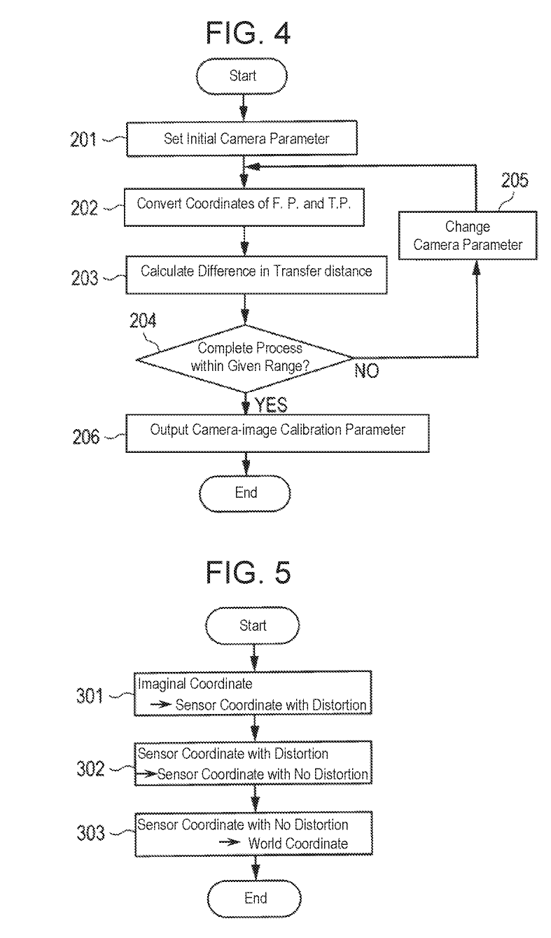

Camera-calibration parameter calculator 105 calculates a calibration parameter. Referring to FIG. 4, detailed processes performed in camera-calibration parameter calculator 105 are described.

First, in a process of initializing a camera parameter (step 201), camera-calibration parameter calculator 105 sets a camera angle (pan, tilt, rolling) and a camera position as an initial parameter of the camera. These set values are included in design data of mounting the camera.

Next, in a process of converting the coordinates of featuring points and tracking points (step 202), camera-calibration parameter calculator 105 converts the imaginal coordinates, stored in memory 102, of the featuring points and the tracking points into world coordinates. The processes in step 202 will be detailed later.

Next, in a process of calculating a difference in transfer distances (step 203), camera-calibration parameter calculator 105 calculates a difference between a transfer distance of each of the featuring points on the world coordinate and an actual transfer distance thereof stored in memory 202, as well as calculates a difference between a transfer distance of each of the tracking points on the world coordinate and an actual transfer distance thereof stored in memory 202. The process in step 203 will be detailed later.

Camera-calibration parameter calculator 105 changes the parameters within a given range, and repeats the processes in steps 202 and 203 (i.e. NO of step 204, and step 205).

After completing the processes in steps 202 and 203 within the given range (i.e. YES of step 204), camera-calibration parameter calculator 105 defines the difference in transfer distance as an evaluation value in a process of outputting a calibration parameter (step 206). The camera parameters (camera angle and position) that make the evaluation value minimum are used as calibration parameters indicating a corresponding relation between an image shot with the camera and an actual road. Then, the calibration parameters are supplied to a camera-image calibrating device (not shown).

The camera-image calibrating device uses the calibration parameters for calibrating an image displayed on a vehicle-mounted monitor (not shown).

With reference to FIG. 5-FIG. 7, the coordinates conversion processes for the featuring point and the tracking point (step 202) are demonstrated hereinafter. To be more specific, the process of converting the imaginal coordinates of featuring points stored in memory 102 into the world coordinates as well as the process of converting the imaginal coordinates of tracking points stored in memory 102 into the world coordinates is detailed.

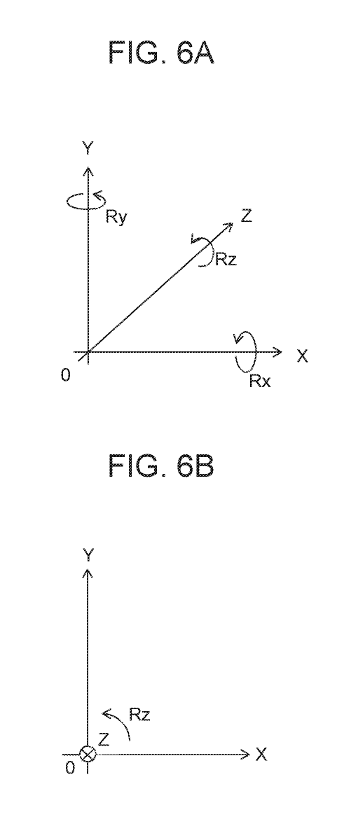

The world coordinates refer to a three-dimensional coordinate system in the real world, and equations (1)-(4) below show the relation between world coordinate (Xw, Yw, Zw) and camera coordinate (Xc, Yc, Zc). This relation is determined by such parameters as rotation matrix R and translation matrix T. In the world coordinates, axes X, Y, and Z are prepared as shown in FIG. 6A, where a counterclockwise rotations, viewed from the origin, about axes X, Y, and Z are referred to as forward rotations. Rx indicates a rotational angle with respect to axis X, Ry indicates a rotational angle with respect to axis Y, and Rz indicates a rotational angle with respect to axis Z. For instance, the rotation about axis Z shown in FIG. 6B is a counterclockwise rotation with respect to a forward direction from the origin, so that this rotation counts a forward angle of Rz. The same description can be applied to Rx and Ry.

$$\begin{matrix} [ \begin{matrix}{X}_{C} \\ {Y}_{C} \\ {Z}_{C}\end{matrix} ] = R [ \begin{matrix}{X}_{w} \\ {Y}_{w} \\ {Z}_{w}\end{matrix} ] + T & Equation ( 1 ) \\ R = [ \begin{matrix}{r}_{1} & {r}_{2} & {r}_{3} \\ {r}_{4} & {r}_{5} & {r}_{6} \\ {r}_{7} & {r}_{8} & {r}_{9}\end{matrix} ] & Equation ( 2 ) \\ T = [ \begin{matrix}{T}_{x} \\ {T}_{y} \\ {T}_{z}\end{matrix} ] & Equation ( 3 ) \\ R = [ \begin{matrix}cos {R}_{z} & sin {R}_{z} & 0 \\ - sin {R}_{z} & cos {R}_{z} & 0 \\ 0 & 0 & 1\end{matrix} ] [ \begin{matrix}cos {R}_{y} & 0 & - sin {R}_{y} \\ 0 & 1 & 0 \\ sin {R}_{y} & 0 & cos {R}_{y}\end{matrix} ] [ \begin{matrix}1 & 0 & 0 \\ 0 & cos {R}_{x} & sin {R}_{x} \\ 0 & - sin {R}_{x} & cos {R}_{x}\end{matrix} ] & Equation ( 4 )\end{matrix}$$

As shown in FIG. 5, in step 301, camera-calibration parameter calculator 105 converts the supplied imaginal coordinates (imaginal x coordinate and imaginal y coordinate) into a sensor coordinate with distortion (sensor x coordinate with distortion and sensor y coordinate with distortion). Equations (5) and (6) indicate the relation between the imaginal coordinates and the sensor coordinates with distortion. As pixel pitches along axes X and Y, and an image center, the values stored in memory 102 as in-camera parameters are used.

Sensor x coordinate with distortion=pixel pitch along X direction×(imaginal x coordinate−image center along X direction) Equation (5)

Sensor y coordinate with distortion=pixel pitch along Y direction×(imaginal y coordinate−image center along Y direction) Equation (6)

In step 302, camera-calibration parameter calculator 105 converts the sensor coordinates with distortion into sensor coordinates with no distortion (i.e. sensor x coordinate with no distortion, sensor y coordinate with no distortion). Equations (7)-(9) indicate the relations between the sensor coordinates with distortion and the sensor coordinates with no distortion. In equation (7), “kappa 1” represents a lens-distortion correction coefficient and is a known value. As the lens-distortion correction coefficient, a value stored as an in-camera parameter in memory 102.

Distortion coefficient=1.0+(kappa 1×((sensor x coordinate with distortion)²+(sensor y coordinate with distortion))²)) Equation (7)

Sensor x coordinate with no distortion=(sensor x coordinate with distortion)×distortion coefficient Equation (8)

Sensor y coordinate with no distortion=(sensor y coordinate with distortion)×distortion coefficient Equation (9)

In step 303, camera-calibration parameter calculator 105 converts the sensor coordinates with distortion into the world coordinates. Equations (10)-(14) indicate the relations between the sensor coordinates with no distortion and the world coordinates.

Sensor x coordinate with no distortion=(focal distance f×camera x coordinate Xc)÷coordinate z camera Zc Equation (10)

Equation (10) can be converted into an equation of finding camera x coordinate Xc.

Camera x coordinate Xc=(sensor x coordinate with no distortion÷focal distance f)×camera z coordinate Zc Equation (11)

Sensor y coordinate with not distortion=(focal distance f×camera y coordinate Yc)÷camera z coordinate Zc Equation (12)

Equation (12) can be converted into an equation of finding camera y coordinate Yc.

Camera y coordinate Yc=(sensor y coordinate with no distortion÷focal distance f)×camera z coordinate Zc Equation (13)

Rotation matrix R and translation matrix T in equation (1) have been already determined, and the featuring points as well as the tracking points are on the road surface (world y coordinate Yw=0). These conditions allow camera-calibration parameter calculator 105 to calculate world x coordinate Xw, world z coordinate Zw because the three-dimensional equation expressed in equation (14) can be found from equations (1), (11) and (13).

r₁·X_{w}+r₃·Z_{w}−(sensor x coordinate with no distortion÷focal distance f)×Z_{C}+Tₓ=0,

r₄·X_{w}+r₆·Z_{w}−(sensor y coordinate with no distortion÷focal distance f)×Z_{C}+T_{y}=0, and

r₇·X_{w}+r₉·Z_{w}−Z_{C}+T_{z}=0 Equation (14)

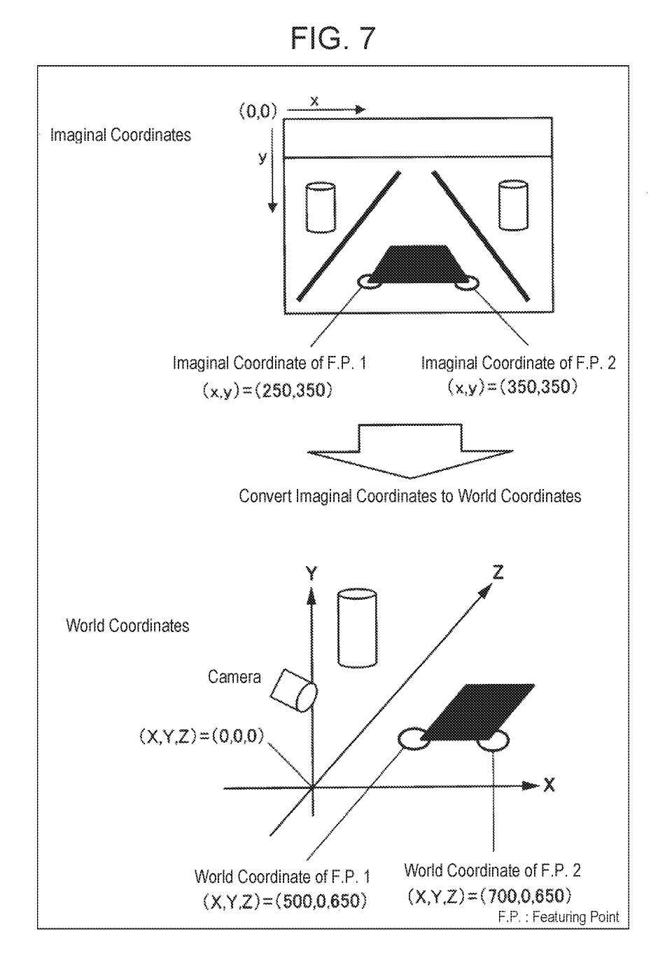

As discussed above, an execution of the flow shown in FIG. 5 allows converting the imaginal coordinates of each one of the featuring points and each one of the tracking points into the world coordinates as shown in FIG. 7, in which the origin is set as a point determined by dropping vertically the top of the optical axis of the camera onto the road surface, and the values shown in the imaginal coordinates shown in FIG. 2 are used as an example.

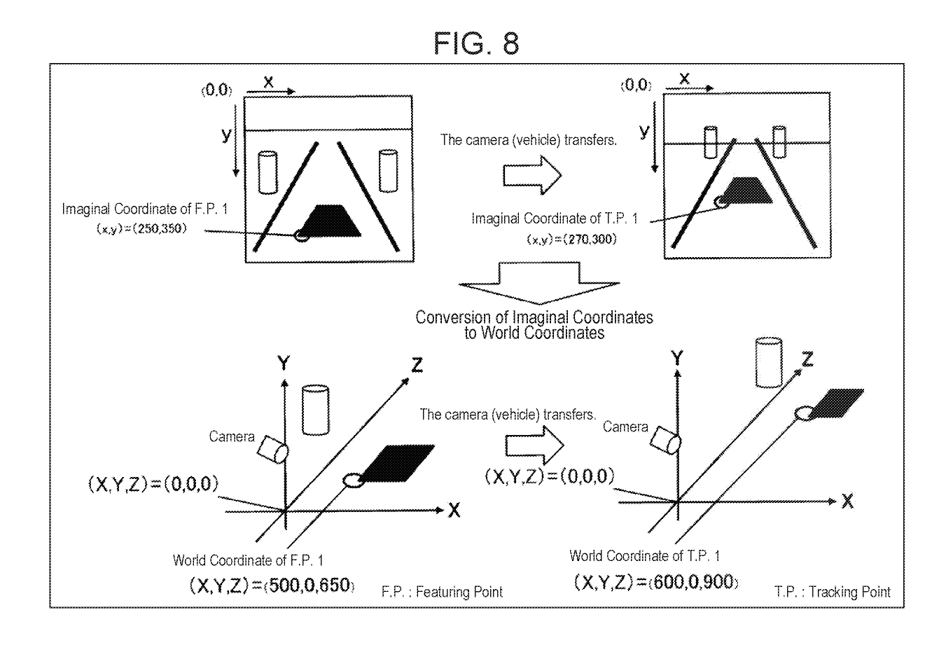

Next, the process of calculating the difference in the transfer distance (step 203) is detailed hereinafter with reference to FIG. 8.

Camera-calibration parameter calculator 105 calculates transfer distances along Z-axis and X-axis, of the featuring points and the tracking points converted into the world coordinates by using equation (15).

transfer distance along Z-axis of the world coordinates=(Z-axis of the tracking point−Z-axis of the featuring point), and

transfer distance along X-axis of the world coordinates=(X-axis of the tracking point−X-axis of the featuring point) Equation (15)

Next, camera-calibration parameter calculator 105 calculates a difference between the transfer distances of each of the featuring points and corresponding one of the tracking points on the world coordinates and the actual transfer distances of the mobile body stored in memory 102 by using equation (16). This calculation result is referred to as a difference in transfer distance. In this case, the actual transfer distances of the mobile body (vehicle) are calculated based on the information (e.g. vehicle-speed pulses, steering angle information, vehicle speed) about the transfer distances obtained from vehicle 106, and the calculation result is stored in memory 102. If no misalignment is found at the camera mounting, the difference between the transfer distances calculated based on the camera parameter and the actual transfer distances of the vehicle would be 0 (zero).

difference in transfer distance (evaluated value)=(Σᵢ₌₁ⁿ|(transfer distance along depth line−transfer distance along Z axis of the world coordinates)|+Σᵢ₌₁ⁿ|(transfer distance along lateral line−transfer distance along X axis of the world coordinates)|) Equation (16)

In the example shown in FIG. 8, the use of equations (15) and (16) allows converting the imaginal coordinates (x, y)=(250, 350) of featuring point 1 into the world coordinates (X, Y, Z) of featuring point 1=(500, 0, 650), and converting the imaginal coordinates (x, y)=(270, 300) of tracking point 1 into the world coordinates (X, Y, Z) of tracking point 1=(600, 0, 900).

Also in the example shown in FIG. 8, according to equation (15), the transfer distance along X-axis on the world coordinates can be found by subtracting X-coordinate of featuring point 1 from X-coordinate of the tracking point 1, viz. 600-500=100. In the same manner, transfer distance along Z-axis on the world coordinates can be found by subtracting Z-coordinate of featuring point 1 from Z-coordinate of the tracking point 1, viz. 900-650=250.

Assume that the transfer distances of the mobile body along the depth line is 230, and along the lateral line is 90, respectively, the difference in transfer distance (evaluated value) is |(230−250)|+|(900−100)|=30, according to equation (16).

As discussed above, the present exemplary embodiment proves that the use of the featuring points and the tracking points of the images shot during the transfer of the vehicle allows calculating the transfer distance in the real world, thereby calculating a calibration parameter. Therefore, there is no need for vehicles to stop on the assembly line, and the camera images can be calibrated done automatically when vehicles are transferred on the assembly line.

### Second Exemplary Embodiment

The present disclosure is not limited only to the first exemplary embodiment discussed above, but an embodiment partially modified is applicable to the present disclosure. A second exemplary embodiment of the present disclosure is detailed hereinafter with reference to the accompanying drawings.

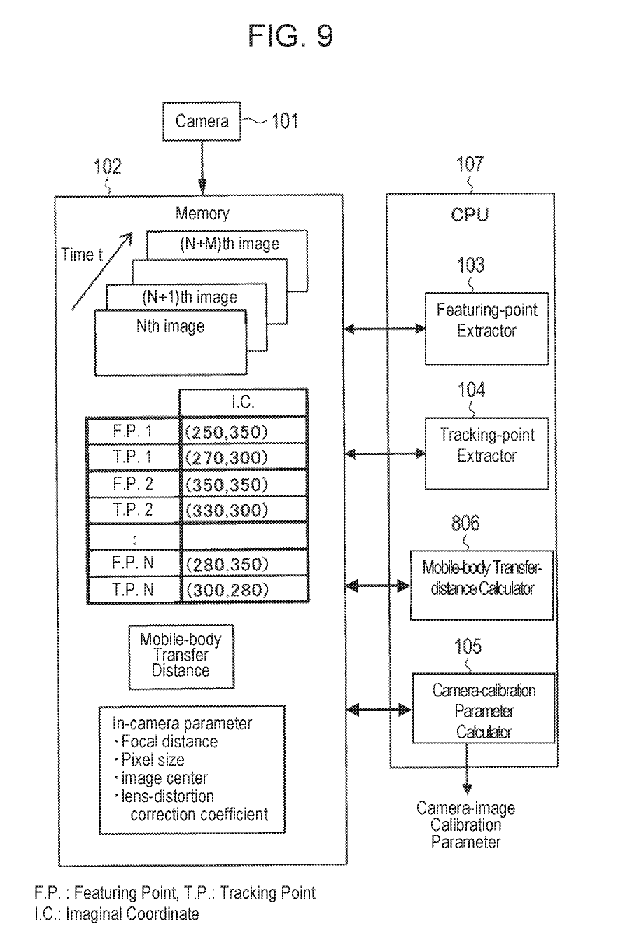

FIG. 9 is a block diagram showing a functional structure of a camera calibrating device in accordance with the second exemplary embodiment. In the camera calibrating device shown in FIG. 9, structural elements similar to those in the camera calibrating device shown in FIG. 1 have the same reference marks, and the description thereof are omitted here. The camera calibrating device shown in FIG. 9 differs from that shown in FIG. 1 in the presence of mobile-body transfer-distance calculator 806 that is added in CPU 107.

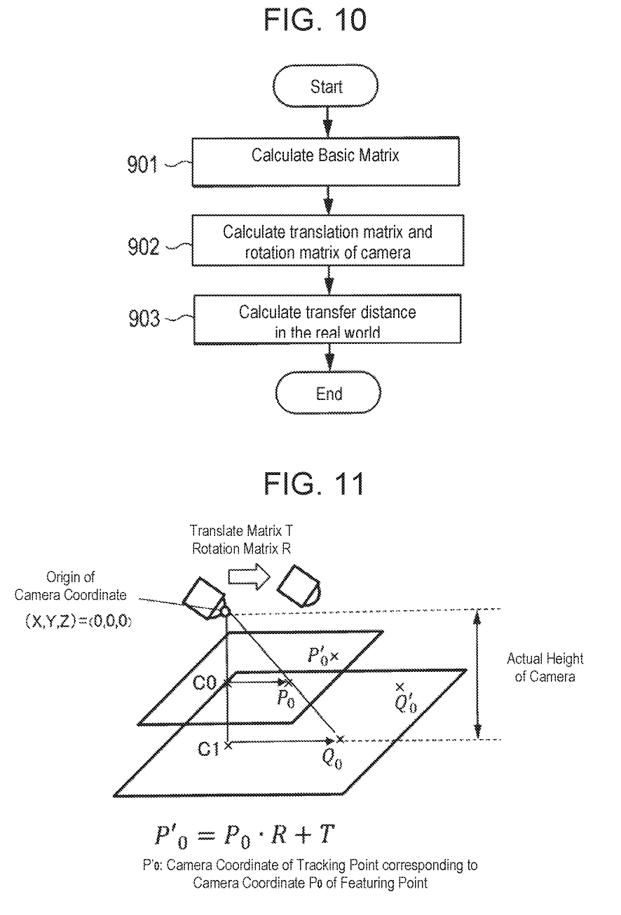

Mobile-body transfer-distance calculator 806 calculates a transfer distance of a mobile body (vehicle). The process done in mobile-body transfer-distance calculator 806 is detailed below with reference to FIG. 10.

First, in the process of calculating a basic matrix (step 901), mobile-body transfer-distance calculator 806 receives an input, viz. combinations of the imaginal coordinates of the featuring point and the tracking point corresponding to each other, viz. (xα, yα), (x′α,y′α), α=1, . . . , N (≥8), and then calculates matrix F by using equation (17).

$$( ( \begin{matrix}x \\ y \\ f\end{matrix} ) , ( \begin{matrix}{F}_{11} & {F}_{12} & {F}_{13} \\ {F}_{21} & {F}_{22} & {F}_{23} \\ {F}_{31} & {F}_{32} & {F}_{33}\end{matrix} ) ( \begin{matrix}{x}^{′} \\ {y}^{′} \\ f\end{matrix} ) ) = 0 \qquad Equation ( 17 )$$

Matrix F=(Fij) (i=1~3, j=1~3) is a basic matrix, and f represents a focal distance.

Next, in the process (step 902) of calculating translation matrix T and rotation matrix R of the camera, mobile-body transfer-distance calculator 806 calculates relative translation matrix T (unit matrix) and relative rotation matrix R of camera 101 from basic matrix F and focal distance f by using equation (18).

$$E = diag ( 1 , 1 , \frac{{f}_{0}}{f} ) F diag ( 1 , 1 , \frac{{f}_{0}}{{f}^{′}} ) \qquad Equation ( 18 )$$

Since the focal distance is retained as an interior parameter, f₀=f=f′ is established. Assume that a unit characteristic vector to the minimum characteristic value of symmetric matrix EE^{T} is translation matrix T.

Matrix—T×E undergoes a singular value decomposition as shown in equation (19).

−T×E=Udiag(σ₁,σ₂,σ₃)V^{T} Equation (19)

Rotation matrix R is calculated by using equation (20).

R=Udiag(1,1,det(UV^{T}))V^{T} Equation (20)

Next, in the step of calculating a transfer distance in the real world (step 903), mobile-body transfer-distance calculator 806 calculates the transfer distance in the real world from the relative translation matrix T and the relative rotation matrix R of the camera. Step 903 is detailed hereinafter with reference to FIG. 11, in which the point (featuring point) of the vehicle, before being transferred, in the camera coordinates, is expressed with P0, and the point (tracking point) after the vehicle is transferred, in the camera coordinates is expressed with P′0. The relation between P0 and P′0 is expressed with equation (21).

P′0=P0·R+T Equation (21)

First, mobile-body transfer-distance calculator 806 calculates an equation of the plane from camera coordinates Pi (i=1, 2, . . . , n) of the featuring points. Since the featuring points are on the road surface, the camera coordinates Pi of the featuring points are located on one single plane. Accordingly, the equation of the plane can be calculated from the camera coordinates Pi. The equation of the plane is shown as equation (22).

ax+by+cz+d=0 Equation (22)

The plane expressed with equation (22) has a normal vector (a, b, c). The straight line orthogonal to this plane is expressed with equation (23).

$$\frac{x}{a} = \frac{y}{b} = \frac{z}{c} \qquad Equation ( 23 )$$

Next, mobile-body transfer-distance calculator 806 calculates a perpendicular line running from the origin of the camera coordinates to the plane, and finds the coordinates of the point of intersection C0 on the basis of equation (24).

$$\begin{matrix}x = \frac{- ad}{{a}^{2} + {b}^{2} + {c}^{2}} \\ y = \frac{- bd}{{a}^{2} + {b}^{2} + {c}^{2}} \\ z = \frac{- cd}{{a}^{2} + {b}^{2} + {c}^{2}}\end{matrix} \} \qquad Equation ( 24 )$$

Since translation matrix T is a unit matrix, the dinstance between the origin of the camera coordinates and intersection point C0 is not equal to the height of the camera. Mobile-body transfer-distance calculator 806 thus extends the straight line between the origin of the camera coordinates and C1, and calculates point C1 equal to the camera height by using a formula (equation (25)) of calculating the distance between the point and the plane. In other words, distance D between plane p0 expressed with equation (22) and point C0 (x0, y0, z0) is expressed with equation (25).

$$D = \frac{\vert {ax}_{0} + {by}_{0} + {cZ}_{0} + d \vert}{\sqrt{{a}^{2} + {b}^{2} + {c}^{2}}} \qquad Equation ( 25 )$$

Since line segment C0-P₀ is parallel to line segment C1-Q₀ in FIG. 11, the coordinate of point Q₀ can be found. In a similar way, the coordinate of point Q′₀ can be found. Mobil-body transfer-distance calculator 806 finds the coordinate of point Q₀ before the transfer of the vehicle and the coordinate of point Q′₀ after transfer of the vehicle, and then finds an average of transfer vectors at camera coordinates Pi (i=1, 2, . . . n) of all the featuring points. The average of transfer vectors is referred to as a transfer distance in the real world, and is stored in memory 102.

As discussed above, the present exemplary embodiment also proves, as similar to the first exemplary embodiment, that there is no need for vehicles to stop on the assembly line, and the camera images can be calibrated automatically when vehicles are transferred on the assembly line.

As stated above, the present disclosure can be used in the vehicle-mounted camera calibration system that calibrates camera images by uning an image shot with the camera.

What is claimed is:

1. A vehicle-mounted camera calibration system comprising:
a camera mounted to a vehicle and configured to sequentially shoot images of a road surface;
a memory configured to chronologically store the images shot with the camera;
a featuring-point extractor configured to extract a featuring point from each of the shot images stored in the memory;
a tracking-point extractor configured to extract a tracking point representing a position to which the featuring point has been transferred after a lapse of a given time; and
a camera-calibration parameter calculator configured to calculate a calibration parameter from the featuring point and the tracking point, the calibration parameter being to be used for calibrating images shot by the camera.

2. The vehicle-mounted camera calibration system according to claim 1, wherein an execution of a program by a CPU (central processing unit) allows the featuring-point extractor to implement the extraction of the featuring point.

3. The vehicle-mounted camera calibration system according to claim 1, wherein an execution of a program by a CPU (central processing unit) allows the tracking-point extractor to implement the extraction of the tracking point.

4. The vehicle-mounted camera calibration system according to claim 1, wherein an execution of a program by a CPU (central processing unit) allows the camera-calibration parameter calculator to implement the calculation.

5. The vehicle-mounted camera calibration system according to claim 1, wherein the camera-calibration parameter calculator calculates the calibration parameter by converting imaginal coordinates of the featuring point and imaginal coordinates of the tracking point to world coordinates.

6. The vehicle-mounted camera calibration system according to claim 5, wherein vehicle speed information and rudder angle information of the vehicle are obtained for calculating a transfer distance of the vehicle, and the calculated transfer distance is stored in the memory.

7. The vehicle-mounted camera calibration system according to claim 5, further comprising a mobile-body transfer-distance calculator configured to calculate a basic matrix from the featuring point extracted by the featuring-point extractor and the tracking point extracted by the tracking-point extractor, and then calculate a transfer distance of the vehicle from the calculated basic matrix.

8. The vehicle-mounted camera calibration system according to claim 6, wherein the camera-calibration parameter calculator calculates the calibration parameter based on the transfer distance of the vehicle and the world coordinates.

9. The vehicle-mounted camera calibration system according to claim 7, wherein the camera-calibration parameter calculator calculates the calibration parameter based on the transfer distance of the vehicle and the world coordinates.
